(19) United States
(12) Patent Application Publication
(10) Pub. No.: US 2008/0134842 A1
(43) Pub. Date: Jun. 12, 2008

(54) Biasing member for biasing bead in the driving member of ratchet wrenches

(76) Inventor: Cheng-Ching Hung, Fenyuan Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/634,892

(22) Filed: Dec. 7, 2006

(51) Int. Cl. B25B 13/46

(52) U.S. Cl. 81/60

(57) ABSTRACT

A wrench includes a driving member engaged with the receiving hole in the head of the wrench and a protrusion extends from an underside of driving member so that a socket is mounted to the protrusion. An axial passage is defined in the driving member and a radial hole is defined through a wall of the protrusion and communicates with the axial passage. An elongate C-shaped biasing member is inserted into the axial passage and a bead is movably engaged with the radial hole and biased by the elongate C-shaped biasing member which biases the bead toward the radial hole. The elongate C-shaped biasing member can be easily removed form the axial passage when needed.

### FIELD OF THE INVENTION

The present invention relates to a C-shaped and thin biasing member axially inserted in an axial passage in the driving member of ratchet wrenches so as to biasing the bead and not to block the light beam from an LED bulb installed in the passage.

### BACKGROUND OF THE INVENTION

A conventional ratchet wrench is shown in FIG. 8 and generally includes a handle 6 having a head at an end thereof and a receiving hole 61 is defined in the head. A driving member 7 is rotatably received in the receiving hole 61 and includes a body 71 which has teeth 711 defined in an outer periphery thereof so as to be engaged with a ratchet mechanism (not shown) in the head. The driving member 7 has a protrusion 72 extending from an underside thereof and the protrusion 72 extends out form the head of the wrench. A passage 73 is defined axially through the protrusion 72 and a recess 712 is defined in a top of the driving member 7, wherein the passage 73 communicates with the recess 712. A radial hole 721 is defined through a wall of the protrusion 72 and a notch 722 is defined in an inner periphery of the passage 73. A bead 74 is engaged with the radial hole 721 and biased by a spring 75 which has one end contacting the bead 74 and the other end of the spring 75 is engaged with the notch 722. A socket 9 is mounted onto the protrusion 72 and a part of the bead 74 extends out from the radial hole 721 and is engaged with a recess defined in the socket 9. A Light Emitting Diode unit 8 is fixedly connected to the recess 712 by the threads 81 on the outer periphery of the Light Emitting Diode unit 8. The Light Emitting Diode unit 8 has a switch button 83 on a top thereof and a Light Emitting Diode bulb 82 is connected to the underside of the Light Emitting Diode unit 8. The Light Emitting Diode bulb 82 emits a light beam which passes through the passage 73 to light up the object to be tightened or loosened. However, the spring 75 is located transversely across the passage 73 so that the light beam is partially blocked by the spring 75 and generates shadows on the object. Besides, when mounting or dismounting the socket 9, the bead 74 might be stocked so that the user has to remove the spring 75 from the passage 73 from the passage 73 and it is difficult to remove the spring 75 because it is located a distance from the opening of distal end of the protrusion 72.

The present invention intends to provide an elongate C-shaped biasing member which is axially inserted into the passage of the passage and biases the bead toward the radial hole of the protrusion. The elongate C-shaped biasing member can be easily pulled out from the passage when needed.

### SUMMARY OF THE INVENTION

The present invention relates to a wrench which comprises a handle with a head and a receiving hole is defined in the head so that a driving member is engaged with the receiving hole. The driving member has a protrusion extending from an underside thereof and an axial passage is defined in the connection member. A recess is defined in a top of the driving member and communicates with the axial passage. A radial hole is defined through a wall of the protrusion and communicates with the axial passage. An elongate C-shaped biasing member is inserted into the axial passage and a bead is movably engaged with the radial hole. The bead is biased by the elongate C-shaped biasing member which biases the bead toward the radial hole.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the wrench of the present invention;

FIG. 2 is an exploded view to show the wrench of the present invention wherein a Light Emitting Diode unit is connected to the driving member;

FIG. 3 is a perspective view to show the wrench with the Light Emitting Diode unit of the present invention;

FIG. 4 shows that the bead is biased by the elongate C-shaped biasing member and a part of the bead protrudes out from the radial hole of the protrusion of the driving member;

FIG. 5 shows that the bead is pushed inward by the socket mounted onto the protrusion of the driving member;

FIG. 6 shows a cross sectional view of the wrench with the Light Emitting Diode unit connected thereto;

FIG. 7 shows that the light beam from Light Emitting Diode unit is not blocked by the elongate C-shaped biasing member, and

FIG. 8 shows a cross sectional view of a conventional wrench with the Light Emitting Diode unit connected thereto and the light beam from Light Emitting Diode unit is blocked by the spring.

### DETAILED DESCRIPTION OF THE PREFERRED EMBODIMENT

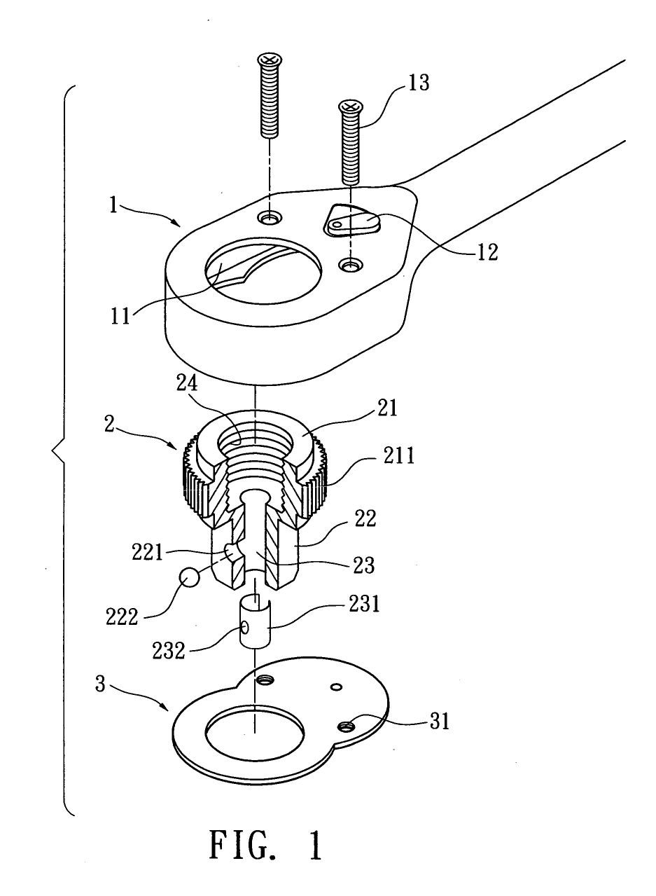

Referring to FIG. 1, the wrench 1 of the present invention comprises a handle with a head connected to an end thereof and a receiving hole 11 is defined in the head. A driving member 2 is engaged with the receiving hole 11 and a neck 21 extends from a top of the driving member 2 and is engaged with a circular hole defined in the top of the head so as to position the driving member 2. A protrusion 22 extends from an underside of the driving member 2 and extends out from the underside of the head. An axial passage 23 is defined in the protrusion 22 and a radial hole 221 is defined through a wall of the protrusion 22 and communicates with the axial passage 23.

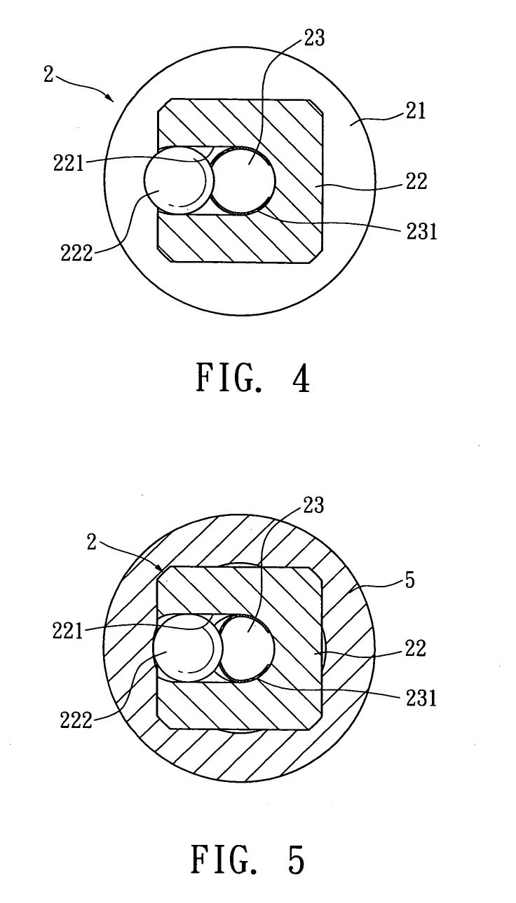

An elongate C-shaped biasing member 231 is inserted into the axial passage 23 from a distal end of the protrusion 22 and the curved outer periphery of the elongate C-shaped biasing member 231 is matched with an inner periphery of the axial passage 23. A bead 222 is movably engaged with the radial hole 221 and biased by the elongate C-shaped biasing member 231 which biases the bead 222 toward the radial hole 221. Preferably, the elongate C-shaped biasing member 231 has an aperture 232 which is smaller than the bead 222 and the bead 222 is partially engaged with the aperture 232, such that the bead 222 is positioned by the aperture 232 as shown in FIG. 4.

A positioning plate 3 is connected to the under side of the head 1 by extending two bolts 13 through the head and threaded connected with two threaded holes 31 in the positioning plate 3. The protrusion 22 extends out from a hole in the positioning plate 3. A ratchet mechanism (not shown) is received in the receiving hole 11 and is controlled by a control lever 12 on the top of the head. The ratchet mechanism is cooperated with outer teeth 211 defined in an outer periphery of the driving member 2.

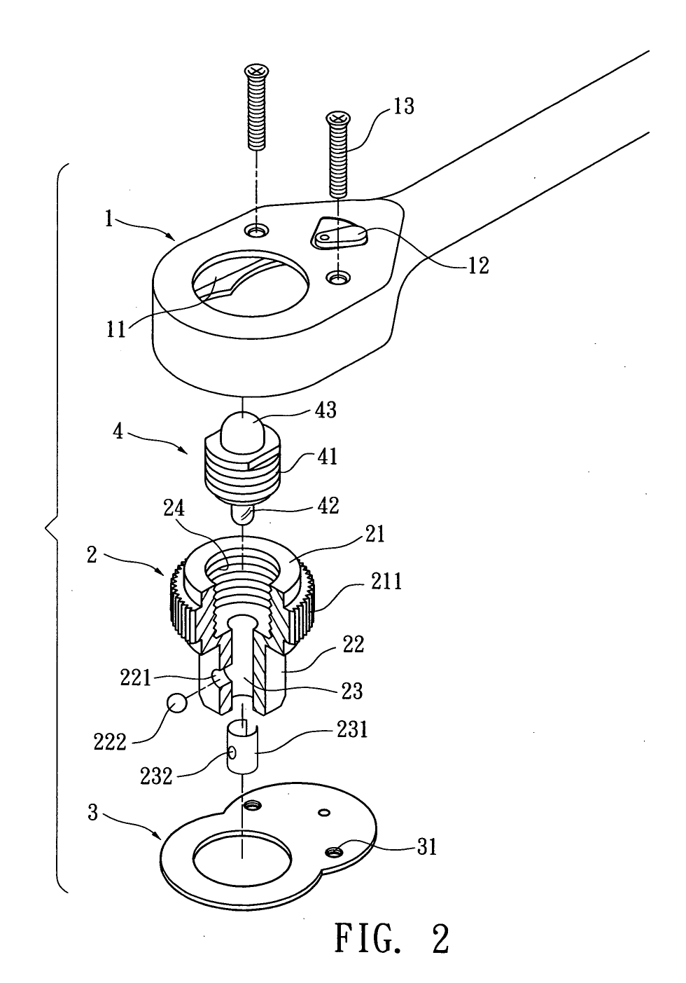

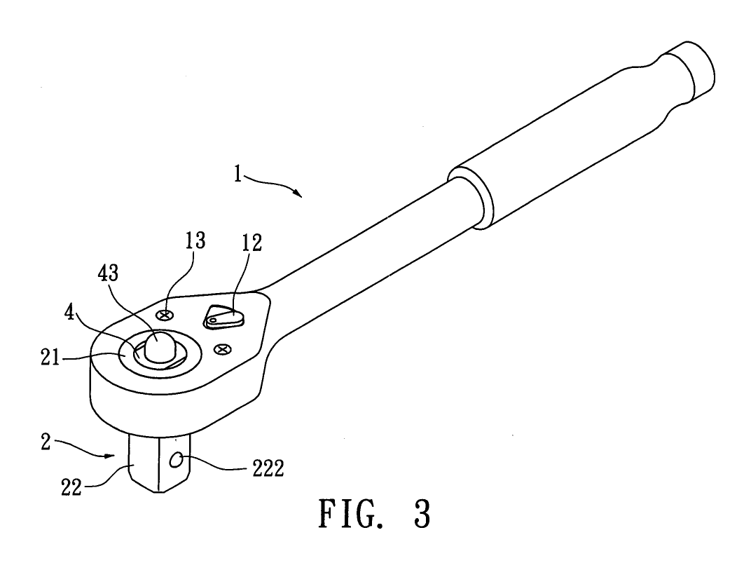

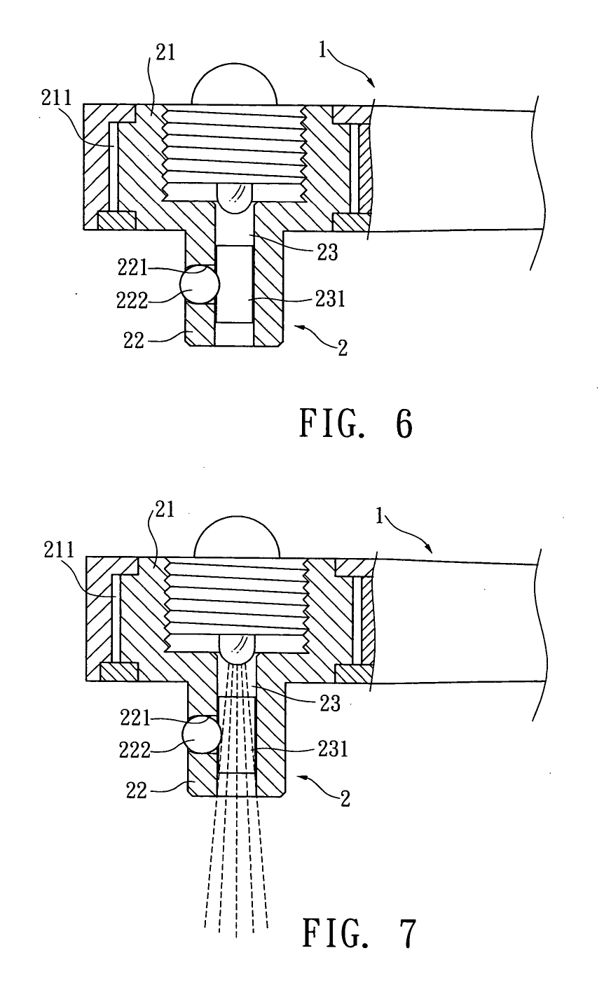

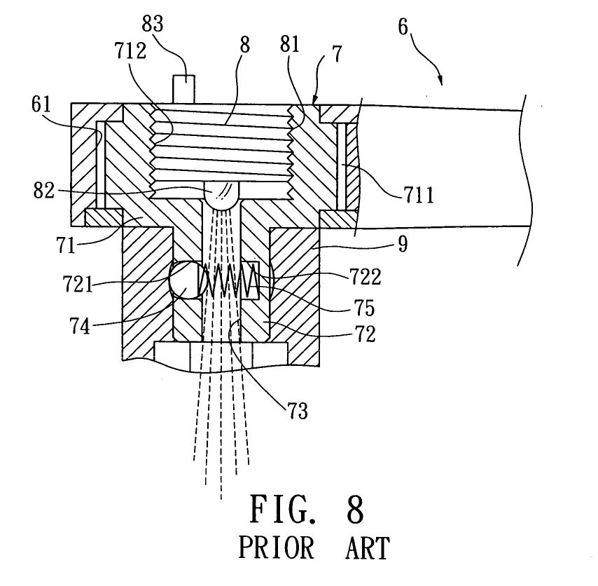

Referring to FIGS. 2 and 3, which shows another embodiment of the present invention, wherein a recess 24 is defined in the top of the driving member 2 and communicates with the axial passage 23. The recess 24 includes inner threads and a Light Emitting Diode unit 4 has outer threads 41 which is threadedly engaged with the inner threads in the recess 24. A switch button 43 is connected on a top of the Light Emitting Diode unit 4 and a Light Emitting Diode bulb 42 is connected to the underside of the Light Emitting Diode unit 4. Referring to FIGS. 5 and 6, the Light Emitting Diode bulb 42 is located corresponding to the axial passage 23 so that the light beam from the Light Emitting Diode bulb 42 passes through the axial passage 23 to light up the object (not shown) to be tightened or loosened. It is noted that the light beam is not blocked by the elongate C-shaped biasing member 231 because the elongate C-shaped biasing member 231 is so thin and matched with the inner periphery of the axial passage 23.

As shown in FIG. 5, when the socket 5 is mounted onto or removed from the protrusion 22, the bead 222 is pushed inward by the socket 5 and the elongate C-shaped biasing member 231 is compressed to allow the bead 222 to be moved inward.

The elongate C-shaped biasing member 231 is easily made and removed from the axial passage 23 of the protrusion 22. Besides, the light beam is not blocked by the elongate C-shaped biasing member 231. When the bead 222 is stocked, the user can pick the thin and elongate C-shaped biasing member 231 easily from the axial passage 23 of the protrusion 22 by pliers.

While we have shown and described the embodiment in accordance with the present invention, it should be clear to those skilled in the art that further embodiments may be made without departing from the scope of the present invention.

What is claimed is:

1. A wrench comprising:
a handle with a head connected thereto and a receiving hole defined in the head;
a driving member engaged with the receiving hole and having a protrusion extending from an underside thereof, the protrusion extending out from an underside of the head and including an axial passage defined therein, a radial hole defined through a wall of the protrusion and communicating with the axial passage, and
an elongate C-shaped biasing member inserted into the axial passage and an outer periphery of the elongate C-shaped biasing member being matched with an inner periphery of the axial passage, a bead movably engaged with the radial hole and biased by the elongate C-shaped biasing member which biases the bead toward the radial hole.

2. The wrench as claimed in claim 1, wherein a recess is defined in a top of the driving member and communicates with the axial passage, the recess includes inner threads and a Light Emitting Diode unit has outer threads which is threadedly engaged with the inner threads in the recess, a switch button is connected on a top of the Light Emitting Diode unit and a Light Emitting Diode bulb is connected to the underside of the Light Emitting Diode unit, the Light Emitting Diode bulb is located corresponding to the axial passage.

3. The wrench as claimed in claim 1, wherein the elongate C-shaped biasing member has an aperture which is smaller than the bead and the bead is partially engaged with the aperture.

4. The wrench as claimed in claim 1, wherein a neck extends from a top of the driving member and is engaged with a circular hole defined in a top of the head so as to position the driving member.

5. The wrench as claimed in claim 1, wherein a positioning plate is connected to the under side of the head by extending two bolts through the head from a top of the head and threaded connected with two threaded holes in the positioning plate.
